(19) United States
(12) Patent Application Publication
(10) Pub. No.: US 2017/0090519 A1
(43) Pub. Date: Mar. 30, 2017

(54) TERMINAL DEVICE

(71) Applicant: NEC Corporation, Tokyo (JP)

(72) Inventors: Chika MIYATAKE, Tokyo (JP); Kenichiro FUJII, Tokyo (JP); Tatsuyuki SHINTANI, Tokyo (JP); Michio NAGAI, Tokyo (JP)

(73) Assignee: NEC Corporation, Tokyo (JP)

(21) Appl. No.: 15/126,736

(22) PCT Filed: Jan. 29, 2015
(86) PCT No.: PCT/JP2015/053160

§ 371 Date: Sep. 16, 2016

(30) Foreign Application Priority Data
Mar. 18, 2014 (JP) 2014-055065

(51) Int. Cl. G06F 1/16

(52) U.S. Cl. CPC G06F 1/1652; G06F 1/1635

(57) ABSTRACT

To make it possible to easily keep a terminal device stable while holding lower corner portions (two corners) at both ends of a terminal device with both hands and while placing the terminal device on a horizontal plane in a curved state, the terminal device, which has a first and second end part that are separated from and oppose each other, is provided with a flexible display device and a first constituent part and second constituent part configured from electronic components. The first constituent part is disposed in the first end part, and the second constituent part is disposed in the second end part.

### TECHNICAL FIELD

The present invention relates to a terminal device and relates particularly to a flexible mobile terminal.

### BACKGROUND ART

Various flexible mobile terminals have been proposed as terminal devices in the past years.

For example, PTL 1 (Japanese Laid-open Patent Publication No. 2008-306244) discloses “a portable terminal device” that is flexible as a whole, consequently fitting well with a person at the time of carrying the device and also having improved durability. The portable terminal device disclosed in PTL 1 includes a plurality of inflexible boards installing electronic devices, and a flexible display with flexibility. A casing holds a entire structure thereof and has some elasticity and flexibility. The plurality of boards, each of which is an inflexible device, are not bendable, but the flexible display, which is a flexible device, the multiple flexible boards, and the casing together are bendable, whereby the device as a whole is bendable.

PTL 2 (Japanese Laid-open Patent Publication No. 2003-76442) discloses “a flexible electronic device” that is thin and lightweight, hence suitable for being carried. Furthermore, the flexible electronic device is less likely to be damaged when being dropped, and has flexibility, consequently reducing the possibility of being damaged due to bending and hard use. The flexible electronic device disclosed in PTL 2 is a personal data appliance (PDA). The electronic device includes an upper part, a lower part, a front part, a back part, a first side part and a second side part. The side parts including the first side part is made of a flexible material, such as polymer, that is capable of sealing the electronic device and keeping the flexibility of the electronic device. An antenna is attached to the inside of the electronic device.

The flexible electronic device disclosed in PTL 2 includes three layers. The first layer is a display layer. The display layer may be a flexible liquid crystal display (LCD) or an organic light emitting device (OLED). The display layer has flexibility and is lightweight. The second layer is adjacent to a lower surface of the display layer and is a circuit board layer. The display layer is approximately the same as the circuit board layer in size and shape. The third layer is connected to a lower surface of the circuit board layer and is a battery layer. The battery layer may be a flexible battery or another flexible power supply. All the structural components of the electronic device are flexible, and hence the electronic device as a whole is flexible.

Further, PTL 3 (Japanese Laid-open Patent Publication No. 2014-6892) discloses “a flexible electronic device” that has improved reliability and is capable of preventing any damage due to being bent. The electronic device disclosed in PTL 3 includes a casing, a display surface, and a plurality of buttons. The display surface is part of a display device that displays an image, such as a still image or a video. The display surface, which is flexible, is deformable together with the casing. The casing is made of an elastic resin material, a plastic-deformable metallic material, or a combination of these, for example. The four corners of the casing are rounded. Paired buttons are provided to the casing and are symmetrically disposed so as to have the display surface therebetween. With this structure, a user can perform the operation of pressing any of the buttons and the operation of bending or twisting the electronic device, at the same time, while holding two ends of the electronic device with both of his/her hands. The casing is provided with paired speakers, as audio output device, that are symmetrically disposed so as to have the display surface therebetween. In the casing, paired vibration motors, as vibration device, are symmetrically disposed so as to have the display surface therebetween.

Further, in the electronic device disclosed in PTL 3, various input/output devices are disposed intensively around the four corners of the electronic device to gather inflexible components around the four corners, in order to make the electronic device as a whole flexible. Since at least part of the electronic device is flexible, it is possible to make the display surface bent and to make the display surface twisted.

### CITATION LIST

### Patent Literature

[PTL 1] Japanese Laid-open Patent Publication No. 2008-306244

[PTL 2] Japanese Laid-open Patent Publication No. 2003-76442

[PTL 3] Japanese Laid-open Patent Publication No. 2014-6892

### SUMMARY OF INVENTION

### Technical Problem

PTLs 1 to 3 described above have the following problems.

Regarding the portable terminal device disclosed in PTL 1, since the casing is flexible, the portable terminal device can be temporarily bent by the application of external forces. However, when the external forces are released, the portable terminal device disclosed in PTL 1 returns to the original unbent shape (plane state). Hence, it is difficult for the portable terminal device disclosed in PTL 1 to stably stand on a horizontal plane, such as a tabletop, while keeping the bent state without application of external forces.

Regarding the flexible electronic device disclosed in PTL 2, all the first layer (display layer), the second layer (circuit board layer), and the third layer (display layer) are flexible, and hence the entire device is flexible. With this structure, the flexible electronic device, as the above-described portable terminal device of PTL 1, can be temporarily bent by the application of external forces. However, the flexible electronic device disclosed in PTL 2 also returns to the original plane state when the external forces are released. Hence, it is difficult for the flexible electronic device disclosed in PTL 2, as the above-described portable terminal device of PTL 1, to stably stand on a horizontal plane, such as a tabletop, while keeping the bent state without application of external forces.

In addition, since the flexible electronic device disclosed in PTL 2 returns to the original plane state when external forces are released, external forces need to be constantly and continuously applied to the flexible electronic device with both hands in order to maintain the bent state by holding the corner portions at two sides of the flexible electronic device with both hands. In other words, the structure of PTL 2 also has a problem that it is difficult to continue holding the flexible electronic device in a bent state with both hands.

Further, regarding the electronic device disclosed in PTL 3, since the display surface is flexible, it is possible to make the display surface bent and to make the display surface twisted, by the application of external forces as in the cases of PTLs 1 and 2 described above. However, since the electronic device disclosed in PTL 3 can be easily bent, it is difficult to keep the state of the electronic device being held at the lower corner portions (two corners) of two ends of the electronic device or standing in a bent state on a horizontal plane, such as a tabletop. This is due to the following reason. In the case of holding the lower corner portions (two corners) of the sides of the electronic device or standing the electronic device in a bent state on a horizontal plane when the input/output devices are provided intensively around the four corners of the electronic device, the electronic device becomes distorted due to the load of the input/output devices provided around the two upper ones of the four corners of the electronic device.

In view of the above, an object of the present invention is to provide a terminal device that can be easily and stably held at lower corner portions (two corners) of two end sides with both hands by a user and can stand on a horizontal plane in a bent state.

### Solution to Problem

A terminal device of the present invention provided with first and second end portions that are separate from each other, the terminal device includes:

a flexible display device; and

a first constituent part and a second constituent part each including an electronic component,

wherein the first constituent part is disposed in the first end portion, and the second constituent part is disposed in the second end portion.

### Advantageous Effects of Invention

According to the present invention, a terminal device enables that a user easily and stably holds the terminal device at lower corner portions (two corners) of its two sides with both hands and makes the terminal device stand on a horizontal plane in a bent state.

### BRIEF DESCRIPTION OF DRAWINGS

FIG. 1 is a front perspective view of a terminal device (flexible portable terminal) according to a first exemplary embodiment of the present invention.

FIG. 2 is a cross-sectional view taken along a line II-II in FIG. 1.

FIG. 3 is a detailed cross-sectional view of a part surrounded by a broken-line ellipse A in FIG. 2.

FIG. 4 is an exploded perspective view of the terminal device (flexible portable terminal) illustrated in FIG. 1.

FIG. 5 is a cross-sectional view illustrating the terminal device (flexible portable terminal) illustrated in FIG. 1 in a bent state.

FIG. 6 is a front view illustrating details of a board mounting unit used in the terminal device (flexible portable terminal) illustrated in FIG. 1.

FIG. 7 is a perspective view illustrating the terminal device (flexible portable terminal) illustrated in FIG. 1 in a state of standing on a horizontal plane.

FIG. 8 includes views for explaining the terminal device (flexible portable terminal) illustrated in FIG. 1, part (A) being a perspective view of the terminal device (flexible portable terminal) illustrated in FIG. 1 in a state of being held at two end portions with two hands while keeping a plane state, part (B) being a perspective view of the terminal device (flexible portable terminal) illustrated in FIG. 1 in a state of being held at the two end portions with two hands while keeping a bent state.

FIG. 9 is a front perspective view of a terminal device (flexible portable terminal) according to a second exemplary embodiment of the present invention.

FIG. 10 is a detailed cross-sectional view of a part surrounded by a broken-line circle C in FIG. 9.

FIG. 11 includes views for explaining the terminal device (flexible portable terminal) illustrated in FIG. 9, part (A) being a partial cross-sectional view illustrating the terminal device (flexible portable terminal) illustrated in FIG. 9 in a state immediately before being dropped, part (B) being a partial cross-sectional view illustrating the terminal device (flexible portable terminal) illustrated in FIG. 9 in a state immediately after being dropped.

FIG. 12 is an external perspective view of a terminal device (flexible portable terminal) according to a third exemplary embodiment of the present invention.

FIG. 13 is a front view of a terminal device (flexible portable terminal) according to a fourth exemplary embodiment of the present invention.

FIG. 14 is a front view of a terminal device (flexible portable terminal) according to a fifth exemplary embodiment of the present invention.

FIG. 15 is a front view of a terminal device (flexible portable terminal) according to a sixth exemplary embodiment of the present invention.

FIG. 16 is an external perspective view of a terminal device (flexible portable terminal) according to a seventh exemplary embodiment of the present invention.

FIG. 17 is a front view to explain effects of the terminal devices (flexible portable terminals) illustrated in FIG. 12 to FIG. 16.

FIG. 18 is a lateral cross-sectional view of a terminal device (flexible portable terminal) according to a first modified example of the present invention.

FIG. 19 is a lateral cross-sectional view of a terminal device (flexible portable terminal) according to a second modified example of the present invention.

FIG. 20 is a longitudinal cross-sectional view of a terminal device (flexible portable terminal) according to a third modified example of the present invention.

### DESCRIPTION OF EMBODIMENTS

A flexible portable terminal as a terminal device according to each exemplary embodiment of the present invention is described below with reference to the drawings. In the following drawings, the scale, number and the like in each structure are different from those of the actual structure for the purpose of facilitating understanding the structure.

### First Exemplary Embodiment

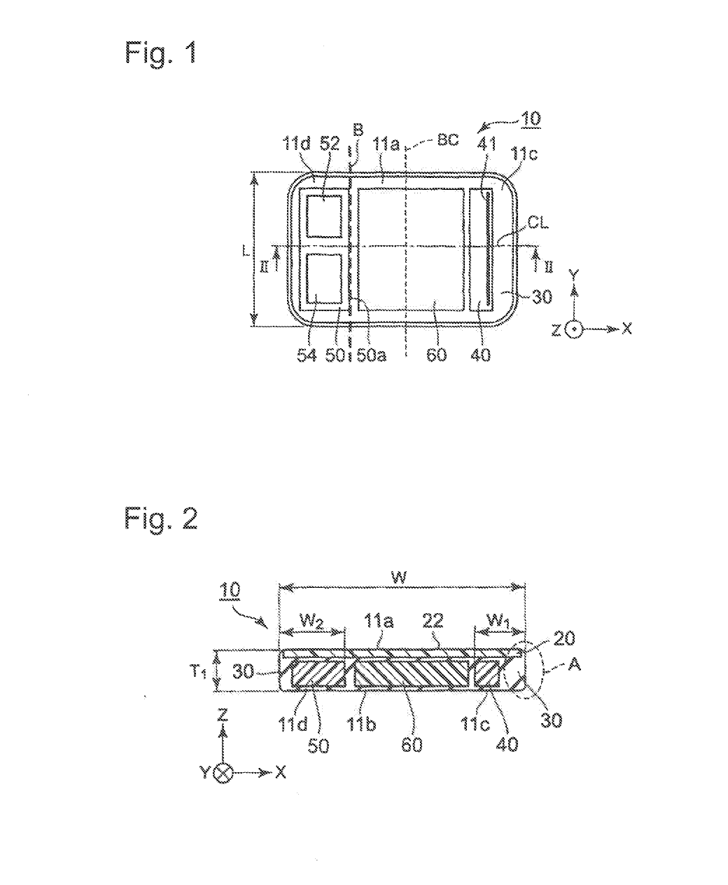

With references to FIG. 1 and FIG. 2, a flexible portable terminal 10 as a terminal device according to a first exemplary embodiment of the present invention is described. FIG. 1 is a front perspective view of the flexible portable terminal 10. FIG. 2 is a cross-sectional view taken along a line II-II in FIG. 1.

The flexible portable terminal 10 substantially has a rectangular shape. The flexible portable terminal 10 includes first and second surfaces 11a and 11b facing each other, and first and second end portions 11c and 11d separate from each other. The first surface 11a is referred to also as a main surface, and the second surface 11b is referred to also as a back surface. The illustrated flexible portable terminal 10 forms a tablet terminal (multifunctional portable terminal) that has substantially the same length and width as those of iPad (registered trademark) or the like with a 10-inch display.

In the following, arrangement each structure is described by setting an orthogonal coordinate system (X, Y, Z) as illustrated in FIG. 1 and FIG. 2. In the state illustrated in FIG. 1 and FIG. 2, in the orthogonal coordinate system (X, Y, Z), an X-axis direction corresponds to a left-right direction (lateral direction; width direction) extending in parallel with the main surface 11a of the flexible portable terminal 10. A Y-axis direction corresponds to a front-rear direction (longitudinal direction; depth direction) extending in parallel with the main surface 11a and being orthogonal to the X-axis direction. A Z-axis direction corresponds to a top-bottom direction orthogonal to the main surface 11a (height direction; thickness direction). Thus, the X-axis direction and the Y-axis direction are orthogonal to each other. The X-axis direction is referred to also as a first direction. The Y-axis direction is referred to also as a second direction. The Z-axis direction is referred to also as a third direction.

FIG. 1 illustrates that the flexible portable terminal 10 is laterally long in the width direction X. The illustrated flexible portable terminal 10 has a shape with the four corners being rounded. In the illustrated example, the first and second end portions 11c and 11d correspond to two respective longitudinal-direction (X-axis-direction) end portions of the flexible portable terminal 10.

As illustrated in FIG. 1 and FIG. 2, the flexible portable terminal 10 has the size of a lateral length (width) W, a longitudinal length (depth) L and a height (thickness) T₁. In the illustrated example, the lateral length (width) W is approximately 240 mm, the longitudinal length (depth) L is approximately 180 mm and the height (thickness) T₁ is approximately 3 mm.

The flexible portable terminal 10 includes a flexible display device 20, a rigid constituent part including rigid electronic components as will be described later, and a flexible casing 30.

The flexible display device 20 includes a display surface (screen) 22 in the main surface 11a. The flexible display device 20 is formed of, for example, an electronic paper of electrically floating type, a light emitting device including light emitting elements such as organic light emitting devices (OLED) for respective pixels, a flexible liquid crystal display (LCD) or the like. The flexible display device 20 is surely not limited to these and may be any display device that is flexible and lightweight.

In the illustrated flexible portable terminal 10, the rigid constituent part includes: a radio unit 40 which includes an antenna 41; a display control unit 52 which controls the flexible display device 20; and a processing unit 54 which performs data processing. In the illustrated example, the display control unit 52 and the processing unit 54 are integrally provided as a single board mounting unit 50.

FIG. 1 is a front perspective view of the flexible portable terminal 10 in a state where the flexible display device 20 is omitted (seen through).

In the first exemplary embodiment, the rigid constituent part is divided into a first rigid constituent part and a second rigid constituent part. The first and second rigid constituent parts are provided respectively in the first and second end portions 11c and 11d.

In the illustrated flexible portable terminal 10, the first rigid constituent part includes the radio unit 40, and the second rigid constituent part includes the board mounting unit 50 (i.e., the display control unit 52 and the processing unit 54).

The radio unit 40 is provided in the range of a first width W₁ in the first end portion 11c. The board mounting unit 50 (the display control unit 52 and the processing unit 54) is provided in the range of a second width W₂ in the second end portion 11d. In the illustrated example, the first width W₁ is in the range between 40 mm and 50 mm, and the second width W₂ is also in the range between 40 mm and 50 mm. It is desirable that each of the first and second widths W₁ and W₂ is such a width as to allow, when the flexible portable terminal 10 is held by a hand, the thumb to reach.

The radio unit 40 is connected to the board mounting unit 50 via an unillustrated flexible printed circuit (FPC). To reduce load due to twist, it is preferable for the connection with the FPC that the FPC be disposed in a Z-shape or the FPC have a pleated structure.

The illustrated flexible portable terminal 10 further includes a flexible battery 60. As illustrated in FIG. 2, the flexible battery 60 is provided on the side provided with the back surface (second surface) 11b in a state of being positioned between the radio unit 40 of being the first rigid constituent part and the board mounting unit 50 of being the second rigid constituent part.

The flexible battery 60 is, for example, an organic radical battery. An organic radical battery is a battery using an organic radical compound, which is a kind of plastic, as an electrode activator. The illustrated flexible battery 60 has a size of, for example, 100 mm by 100 mm in length and width. The flexible battery 60 is not limited to an organic radical battery and may be another flexible battery.

The flexible casing 30 surrounds the flexible display device 20, the first and second rigid constituent parts (the radio unit 40 and the board mounting unit 50) and the flexible battery 60. The flexible casing 30 is a casing with low elasticity, such as rubber, elastomer, or polyethylene terephthalate (PET) film.

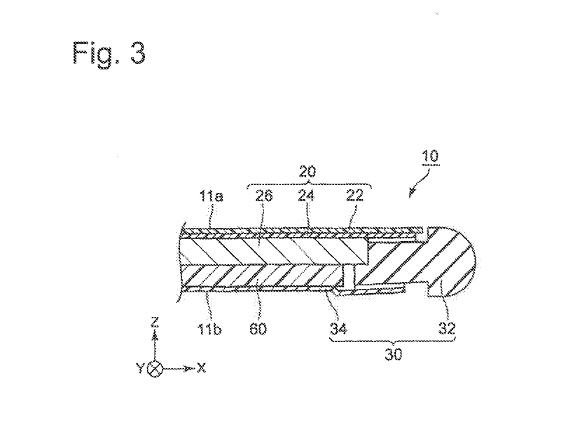

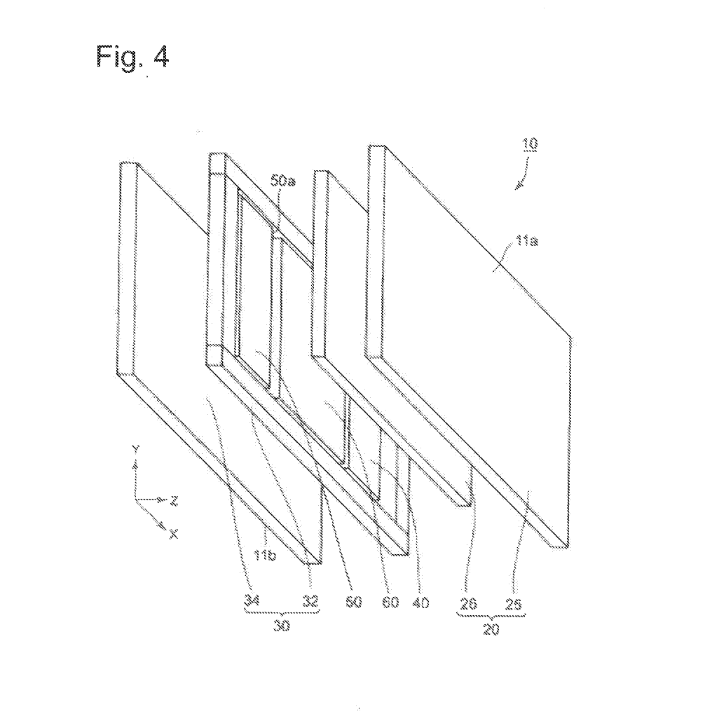

FIG. 3 is a detailed cross-sectional view of a part surrounded by a broken-line ellipse A in FIG. 2. FIG. 4 is an exploded perspective view of the flexible portable terminal 10.

As illustrated in FIG. 3, the flexible display device 20 includes the screen 22, a touch panel 24 and a display device 26. As illustrated in FIG. 4, a front panel 25 of the flexible display device 20 is provided in the main surface (first surface) 11a of the flexible portable terminal 10. The front panel 25 includes the screen 22 and the touch panel 24. The display device 26 is formed on a back surface of the front panel 25.

As the touch panel 24, a resistive or capacitance touch panel may be used.

The flexible casing 30 includes a frame 32 and a rear casing 34. The frame 32 is provided at a peripheral portion of the flexible portable terminal 10. The rear casing 34 is provided at the back surface (second surface) 11b of the flexible portable terminal 10. As illustrated in FIG. 4, the frame 32 surrounds peripheries of the radio unit 40, the board mounting unit 50 and the flexible battery 60. The frame 32 is made, for example, of elastomer. The rear casing 34 is made of a PET film.

As described above, in the terminal device (flexible portable terminal) 10 according to the first exemplary embodiment, the first and second rigid constituent parts (the radio unit 40 and the board mounting unit 50), which include rigid electronic components, are disposed intensively in the first and second end portions 11c and 11d only. As a result of this, the terminal device (flexible portable terminal) 10 as a whole has a flexible structure, except for the portions corresponding to the first and second end portions 11c and 11d. In other words, a central portion of the terminal device (flexible portable terminal) 10 has a flexible structure.

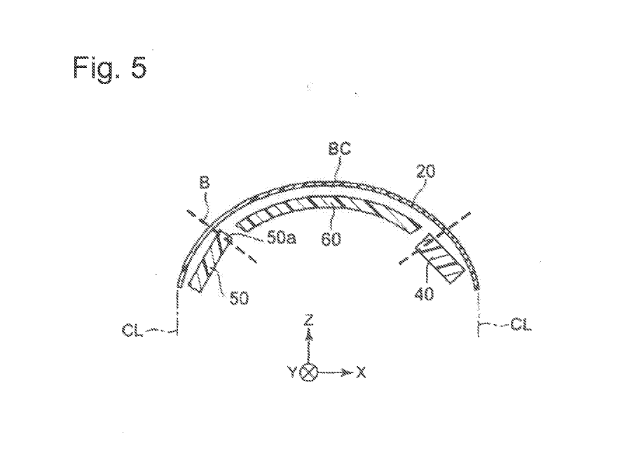

Thus, the flexible portable terminal 10 has a structure that allows the flexible portable terminal 10 to be bendable around a bend center BC orthogonal to a center line CL passing the first end portion 11c and the second end portion 11d as illustrated in FIG. 1 and FIG. 5.

FIG. 5 illustrates a state in which the flexible portable terminal 10 is bent around the bend center BC so that the display surface (screen) 22 is in a convex shape.

Hence, it is possible to easily carry the flexible portable terminal 10 in a state where the central portion is bent. For example, the flexible portable terminal 10 allows to place in a brief case in a state of being bent at the central portion. Alternatively, with the flexibility of the central portion of the flexible portable terminal 10, the flexible portable terminal 10 allows to use in a state of being winded around various objects (e.g., a columnar object).

In FIG. 1 and FIG. 5, a broken line B indicates an edge 50a of the board mounting unit 50, the edge 50a being on the side closer to the bend center BC.

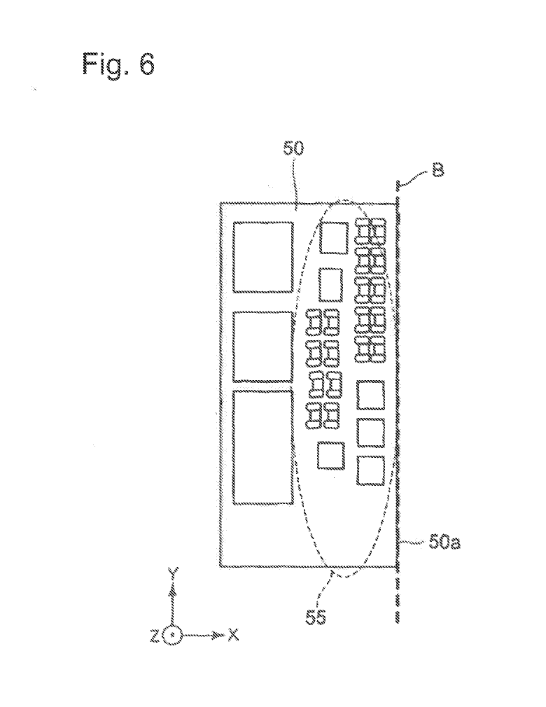

FIG. 6 is a front view illustrating, in an enlarged manner, only the board mounting unit 50 of being the second rigid constituent part in FIG. 1. The board mounting unit 50 includes a plurality of small components 55 disposed on the side closer to the bend center BC (i.e., the side with the edge 50a). The small components 55 are components that have no problem even when being bent. Thus, in the first exemplary embodiment, the plurality of small components 55 in the board mounting unit 50 are disposed intensively around a bend part. With this structure, even when the flexible portable terminal 10 is bent, it is possible to prevent any problem from occurring in the board mounting unit 50.

The first exemplary embodiment of the present invention described above has the following effects.

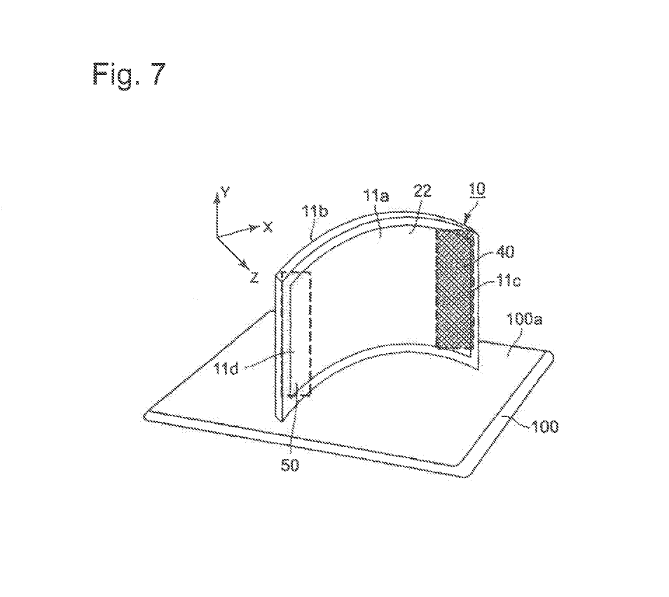

The first effect is that, since the rigid constituent parts (40 and 50) are separately disposed only in the two respective end portions 11c and 11d of the terminal device (flexible portable terminal) 10, the terminal device (flexible portable terminal) 10 enable to easily stand on a horizontal plane such as a surface 100a of a desk 100 while stably keeping a certain bent state as illustrated in FIG. 7. FIG. 7 illustrates a state in which the terminal device (flexible portable terminal) 10 is bent around the bend center BC so that the display surface (screen) 22 is in a concave shape while the first and second end portions 11c and 11d are located at two respective sides of the terminal device (flexible portable terminal) 10.

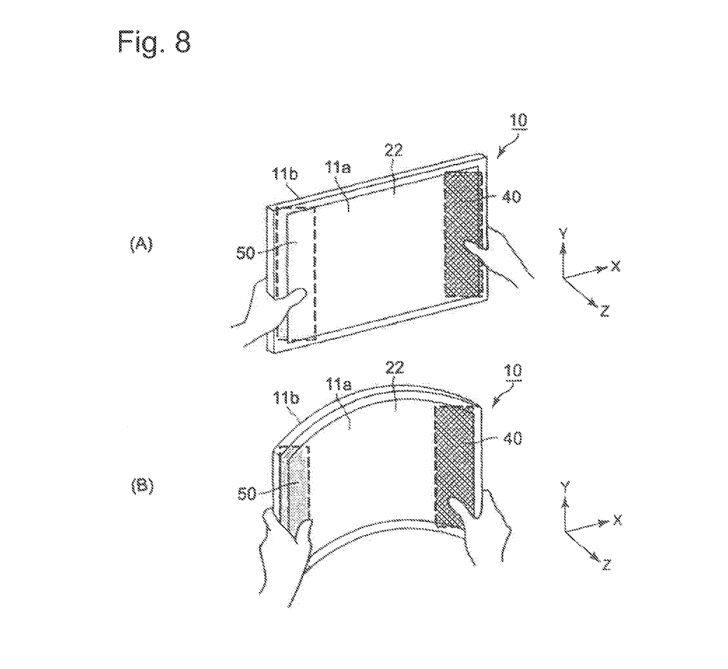

The second effect is that, for example, when the terminal device (flexible portable terminal) 10 is used as an electronic book, as illustrated in a part (A) and a part (B) of FIG. 8, a user can hold (grip) the first and second rigid constituent parts (40 and 50) at the two end portions 11c and 11d with two hands and hence read in the same manner as stably holding a book. If a user does not want that others can see the contents of the book the user is reading, it is easy to keep the terminal device (flexible portable terminal) 10 in a certain stable bent state as illustrated in the part (B) of FIG. 8. The part (B) of FIG. 8 illustrates a state in which the terminal device (flexible portable terminal) 10 is bent around the bend center BC so that the display surface (screen) 22 is in a concave shape while the first and second end portions 11c and 11d are located at two respective sides of the terminal device (flexible portable terminal) 10 as well as FIG. 7. Another advantage is that heat generated in the terminal device (flexible portable terminal) 10 (especially the display device 20) is dispersed in the central portion, hence the terminal device (flexible portable terminal) 10 enable to prevent user's hands from being heated.

The third effect is that, since the radio unit 40 and the board mounting unit 50 are separate from each other, radio characteristics can be improved.

### Second Exemplary Embodiment

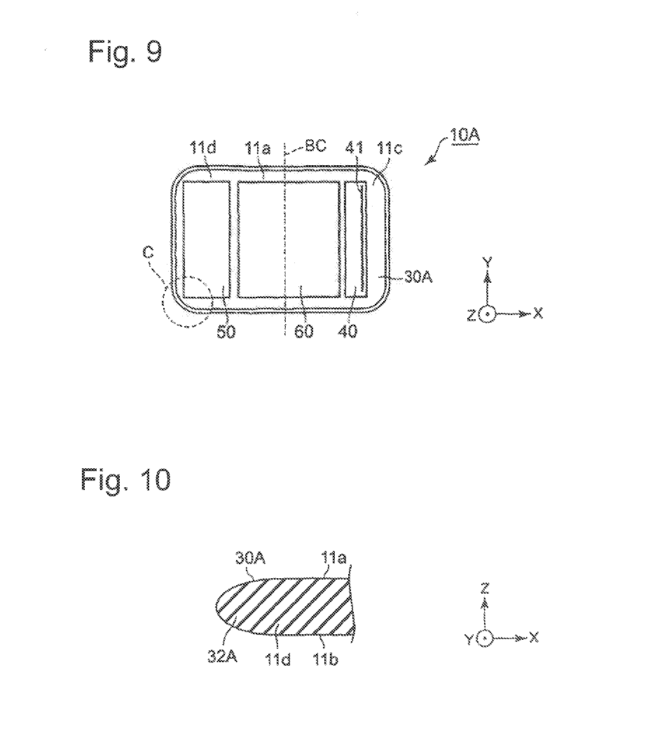

A flexible portable terminal 10A as a terminal device according to a second exemplary embodiment of the present invention is described below with reference to FIG. 9 and FIG. 10. FIG. 9 is a front perspective view of the flexible portable terminal 10A. FIG. 10 is a cross-sectional view illustrating, in an enlarged manner, the part surrounded by a broken-line circle C in FIG. 9.

The illustrated flexible portable terminal 10A has a similar structure to that of the flexible portable terminal 10 illustrated in FIG. 1 to FIG. 6 and operates similarly to the flexible portable terminal 10, except that the flexible portable terminal 10A has a different casing structure. For this reason, the reference sign 30A is assigned to the casing. Otherwise, the same reference signs are assigned to the components having similar functions to those illustrated in FIG. 1 to FIG. 6, and description is given below of the different respects in order to simplify the explanation.

As illustrated in FIG. 10, the casing 30A includes a frame 32A that has a curved surface in a convex shape curving outwards toward the radius direction at a peripheral portion. Thus, the peripheral portion (frame 32A) of the casing 30A has a shape that facilitates sliding.

The second exemplary embodiment of the present invention described above provides the following fourth effect in addition to the first to third effects similar to the first to third effects of the first exemplary embodiment described above.

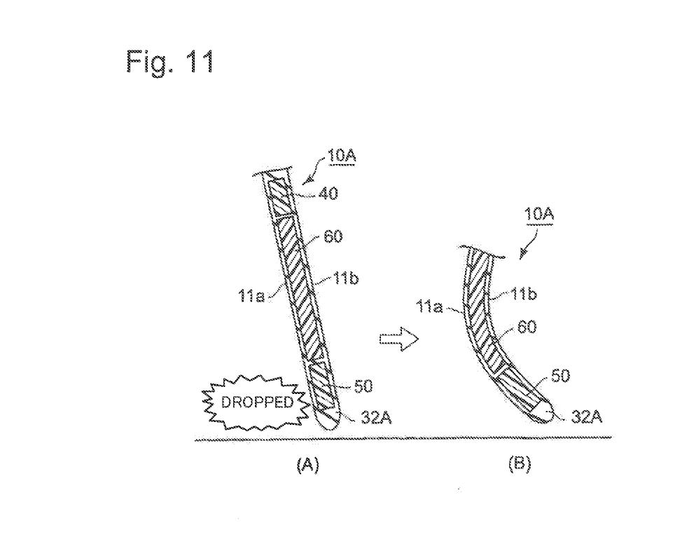

The fourth effect is to be able to provide the terminal device (flexible portable terminal) 10A that is resistant to shocks. The reason is as follows. As illustrated in a part (A) of FIG. 11, assume that the terminal device (flexible portable terminal) 10A is dropped by mistake. In this case, the terminal device (flexible portable terminal) 10A is highly likely to fall from one of the corner portions of the terminal device (flexible portable terminal) 10A. Note that illustration of the flexible display device 20 is omitted in the part (A) of FIG. 11. In this case, as illustrated in a part (B) of FIG. 11, the shock of the terminal device (flexible portable terminal) 10A is received by the frame 32A which is a curved surface in a convex shape in the casing 30A, consequently the terminal device (flexible portable terminal) 10A enable to pass the shock pass. Further, at the drop, the flexible battery 60 serves as a cushion by being bent, and consequently enables to absorb (reduce) the shock.

### Third to Seventh Exemplary Embodiments

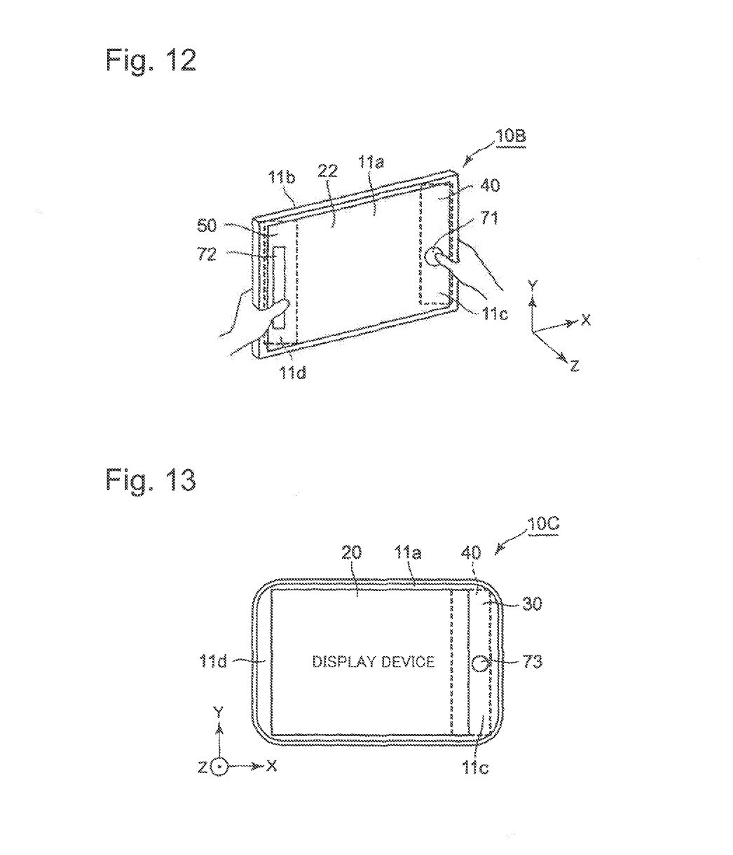

With reference to FIG. 12 to FIG. 16, flexible portable terminals 10B, 10C, 10D, 10E and 1OF as terminal devices according to third to seventh exemplary embodiments of the present invention are described.

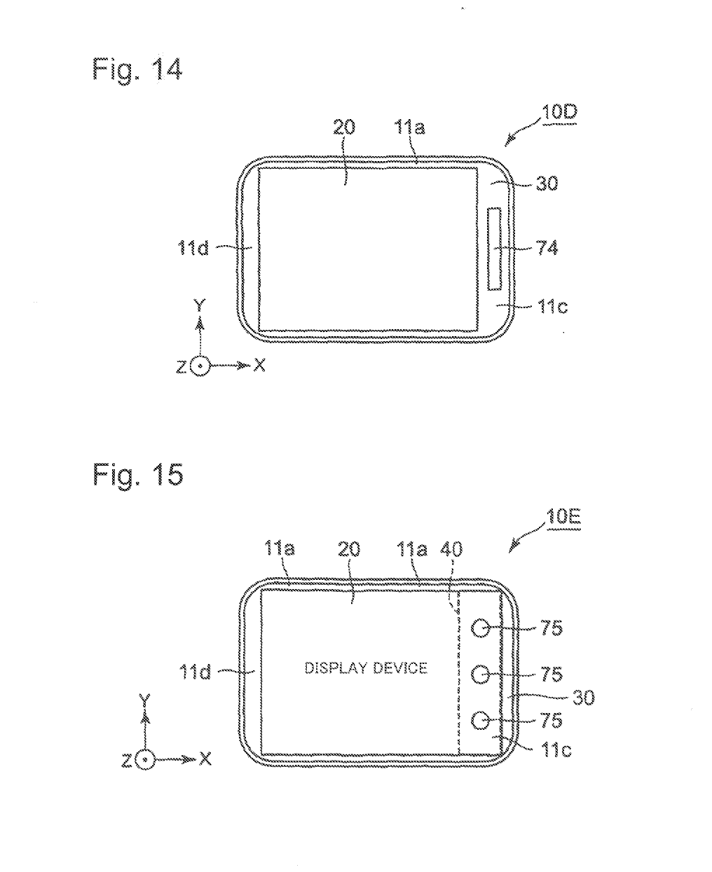

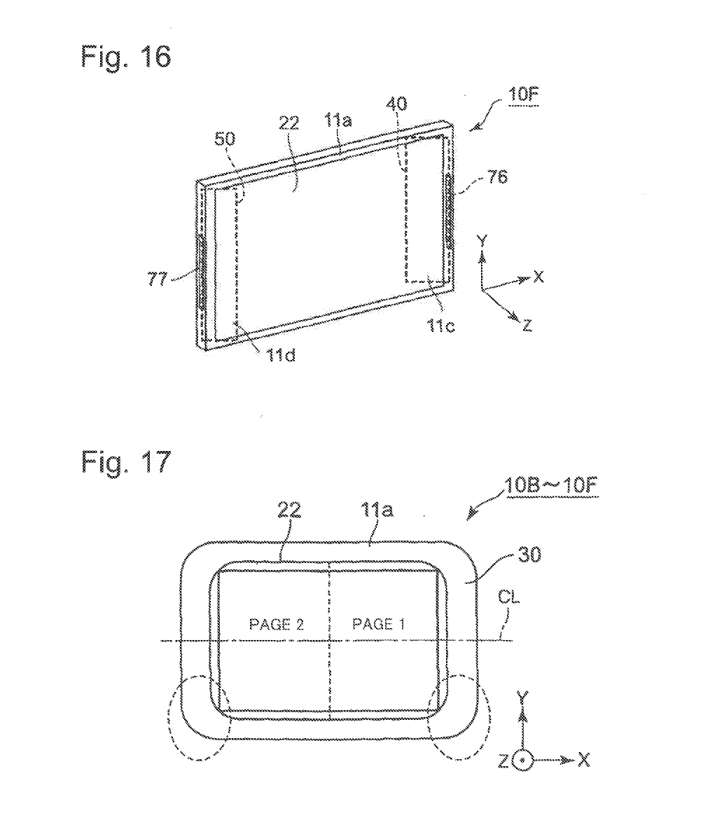

FIG. 12 is an external perspective view of the flexible portable terminal 10B according to the third exemplary embodiment of the present invention. FIG. 13 is a front view of the flexible portable terminal 10C according to the fourth exemplary embodiment of the present invention. FIG. 14 is a front view of the flexible portable terminal 10D according to the fifth exemplary embodiment of the present invention. FIG. 15 is a front view of the flexible portable terminal 10E according to the sixth exemplary embodiment of the present invention. FIG. 16 is an external perspective view of the flexible portable terminal 10F according to the seventh exemplary embodiment of the present invention.

Each of these flexible portable terminals 10B to 10F has a similar structure to the flexible portable terminal 10 illustrated in FIG. 1 to FIG. 6 and operates similarly to the flexible portable terminal 10, except that this flexible portable terminal further includes at least one operation key (to be described later). For this reason, the same reference signs are assigned to the components having similar functions to those illustrated in FIG. 1 to FIG. 6, and description is given below of the different respects in order to simplify the explanation.

With reference to FIG. 12, the flexible portable terminal 10B according to the third exemplary embodiment includes first and second operation keys 71 and 72 respectively in the first and second end portions 11c and 11d of the main surface (first surface) 11a.

Thus, in the third exemplary embodiment, since the operation keys 71 and 72 are provided in the first and second rigid constituent parts (40 and 50), this configuration has an advantage of being easy to operate the flexible portable terminal 10B.

With reference to FIG. 13, the flexible portable terminal 10C according to the fourth exemplary embodiment includes a hard key 73 in the first end portion 11c of the main surface (first surface) 11a in the casing 30 outside the display device 20.

With reference to FIG. 14, the flexible portable terminal 10D according to the fifth exemplary embodiment includes a hard key 74 having a different shape from the hard key 73 in the first end portion 11c of the main surface (first surface) 11a in the casing 30 outside the display device 20.

Thus, in the fourth and fifth exemplary embodiments, since the hard key 73 or 74 is provided in the first constituent part 40 of the first and second rigid constituent parts (40 and 50), these configuration have an advantage of being easy to operate the flexible portable terminal 10C, 10D.

With reference to FIG. 15, the flexible portable terminal 10E according to the sixth exemplary embodiment includes a plurality of (three, in this example) operation buttons 75 on the display device 20 (screen 22) in the first end portion 11c of the main surface (first surface) 11a.

Thus, in the sixth exemplary embodiment, since the plurality of operation buttons 75 are provided in the first constituent part 40 of the first and second rigid constituent parts (40 and 50), this configuration has an advantage of being easy to operate the flexible portable terminal 10E.

With reference to FIG. 16, the flexible portable terminal 10F according to the seventh exemplary embodiment includes first and second operation keys 76 and 77 in respective end surfaces of the casing 30 in the first and second end portions 11c and 11d.

Thus, in the seventh exemplary embodiment, since the operation keys 76 and 77 are provided in the respective first and second rigid constituent parts (40 and 50), this configuration has an advantage of being easy to operate the flexible portable terminal 10F.

The third to seventh exemplary embodiments of the present invention described above provide the following fourth effect in addition to the first to third effects similar to the first to third effects of the first exemplary embodiment described above.

The fourth effect is that it is easy to operate the terminal devices (flexible portable terminals) 10B to 10F. The reason is as follows. For example, when any of the terminal devices (flexible portable terminals) 10B to 10F is used as an electronic book, the terminal device is often held at lower right and left end portions indicated by broken-line ellipses in FIG. 17, with two hands. Since the two end portions of each of the terminal devices (flexible portable terminals) 10B to 10F include the first and second rigid constituent parts (40 and 50), the operability of the terminal devices (flexible portable terminals) 10B to 10F is improved by operating any of the operation keys 71 to 77 with hand. In addition, as illustrated in FIG. 12 to FIG. 16, the flexibility in arrangement of any of the hard keys 71 to 77 increases, whereby the operability of the terminal devices (flexible portable terminals) 10B to 10F increases.

In the first to seventh exemplary embodiments described above, the rigid constituent part is divided into the first rigid constituent part with the radio unit 40 and the second rigid constituent part with the board mounting unit 50 (the display control unit 52 and the processing unit 54). However, division of the rigid constituent part is not limited to this, and the present invention may employ any of various division methods as will be described in the following modified examples.

### MODIFIED EXAMPLE 1

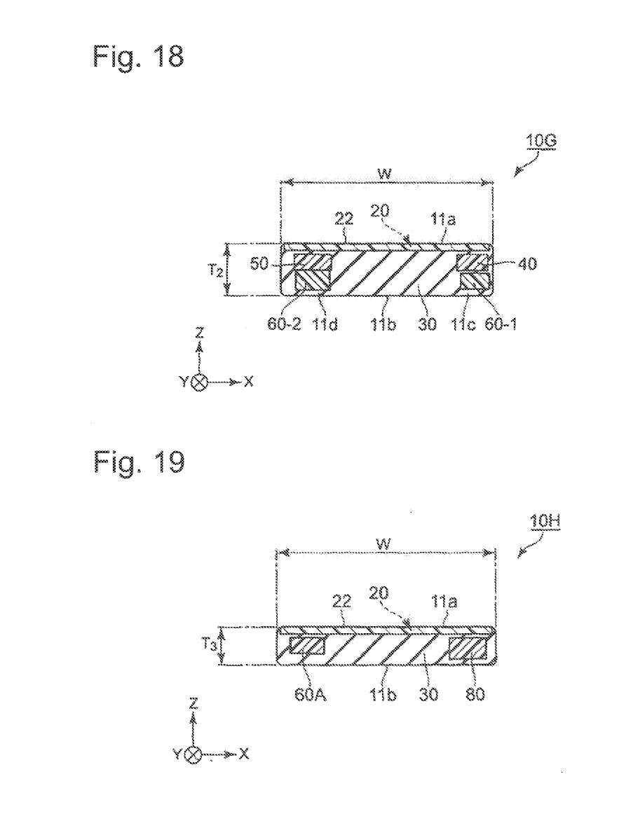

With reference to FIG. 18, a flexible portable terminal 10G as a terminal device according to a first modified example of the present invention is described. FIG. 18 is a lateral cross-sectional view of the flexible portable terminal 10G.

The illustrated flexible portable terminal 10G has a similar structure to the flexible portable terminal 10 illustrated in FIG. 1 to FIG. 6 and operates similarly to the flexible portable terminal 10, except that the flexible portable terminal 10G has a different height (thickness) and includes two separate flexible batteries as will be described later. For this reason, the reference sign T₂ is assigned to the height (thickness), and the reference signs 60-1 and 60-2 are assigned to the two flexible batteries as first and second flexible batteries. Otherwise, the same reference signs are assigned to the components having similar functions to those illustrated in FIG. 1 to FIG. 6, and description is given below only of the different respects in order to simplify the explanation.

In the flexible portable terminal 10 according to the first exemplary embodiment, the single flexible battery 60 is provided in a state of being positioned between the radio unit 40 and the board mounting unit 50 (the display control unit 52 and the processing unit 54) as illustrated in FIG. 2.

In contrast to this, as illustrated in FIG. 18, in the flexible portable terminal 10G according to the first modified example, the first flexible battery 60-1 is disposed so as to overlap with the radio unit 40, and the second flexible battery 60-2 is disposed so as to overlap with the board mounting unit 50.

Further, the height (thickness) T₂ of the flexible portable terminal 10G of the first modified example is thicker than the height (thickness) T₁ of the flexible portable terminal 10 according to the first exemplary embodiment.

As described above, in the flexible portable terminal 10G according to the first modified example, the rigid constituent part is divided into the first rigid constituent part (40 and 60-1), which includes the combination of the radio unit 40 and the first flexible battery 60-1, and the second rigid constituent part (50 and 60-2), which includes the combination of the board mounting unit 50 and the second flexible battery 60-2. The first rigid constituent part (40 and 60-1) is provided in the first end portion 11c, and the second rigid constituent part (50 and 60-2) is provided in the second end portion 11d.

Hence, the flexible portable terminal 10G having the above-described structure is bendable around the bend center BC (see FIG. 1), which is orthogonal to the center line CL (see FIG. 1), as the flexible portable terminal 10 according to the first exemplary embodiment.

The first modified example of the present invention described above provides the first to third effects same as the first to third effects of the first exemplary embodiment described above.

### MODIFIED EXAMPLE 2

With reference to FIG. 19, a flexible portable terminal 10H as a terminal device according to a second modified example of the present invention is described. FIG. 19 is a lateral cross-sectional view of the flexible portable terminal 10H.

The illustrated flexible portable terminal 10H has a similar structure to the flexible portable terminal 10 illustrated in FIG. 1 to FIG. 6 and operates similarly to the flexible portable terminal 10, except that the flexible portable terminal 10H has a different height (thickness) and has a rigid constituent part modified as is described below. For this reason, the reference sign T₃ is assigned to the height (thickness). Otherwise, the same reference signs are assigned to the components having similar functions to those illustrated in FIG. 1 to FIG. 6, and description is given below only of the different respects in order to simplify the explanation.

In the flexible portable terminal 10 according to the first exemplary embodiment, the rigid constituent part includes the radio unit 40 and the board mounting unit 50 (the display control unit 52 and the processing unit 54).

In contrast to this, in the flexible portable terminal 10H according to the second modified example, the rigid constituent part includes a component mounting unit 80 and a rigid battery 60A. The component mounting unit 80 includes the radio unit 40, the display control unit 52 and the processing unit 54 illustrated in FIG. 1 and FIG. 2.

As described above, in the flexible portable terminal 10H according to the second modified example, the rigid constituent part is divided into a first rigid constituent part (80) including the component mounting unit 80 and a second rigid constituent part (60A) including the rigid battery 60A. The first rigid constituent part (80) is disposed in the first end portion 11c, and the second rigid constituent part (60A) is disposed in the second end portion 11d.

The height (thickness) T₃ of the flexible portable terminal 10H of the second modified example is thicker than the height (thickness) T₁ of the flexible portable terminal 10 according to the first exemplary embodiment.

Hence, the flexible portable terminal 10H having the above-described structure is also bendable around the bend center BC (see FIG. 1), which is orthogonal to the center line CL (see FIG. 1), as the flexible portable terminal 10 according to the first exemplary embodiment.

The second modified example of the present invention described above provides the first and second effects similar to the first and second effects of the first exemplary embodiment described above.

### MODIFIED EXAMPLE 3

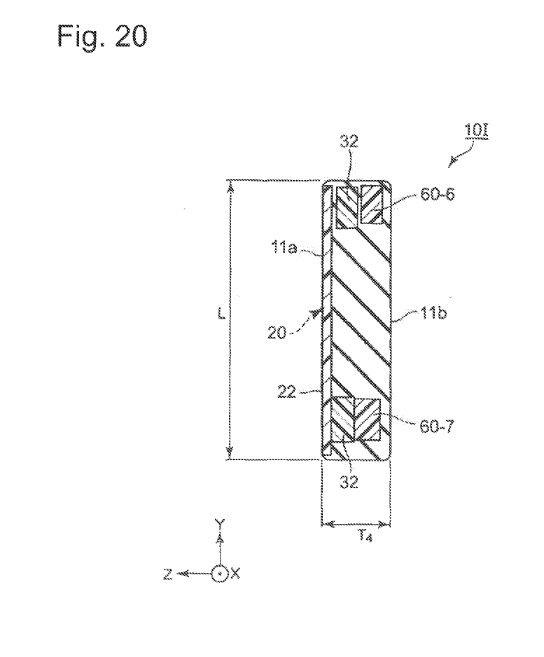

With reference to FIG. 20, a flexible portable terminal 101 as a terminal device according to a third modified example of the present invention is described. FIG. 20 is a longitudinal cross-sectional view of the flexible portable terminal 101.

The illustrated flexible portable terminal 101 has a similar structure to the flexible portable terminal 10 illustrated in FIG. 1 to FIG. 6 and operates similarly to the flexible portable terminal 10, except that the flexible portable terminal 101 has a different height (thickness) and includes two separate flexible batteries as will be described below. For this reason, the reference sign T₄ is assigned to the height (thickness), and the reference signs 60-6 and 60-7 are assigned to the two flexible batteries as first and second flexible batteries. Otherwise, the same reference signs are assigned to the components having similar functions to those illustrated in FIG. 1 to FIG. 6, and description is given below only of the different respects in order to simplify the explanation.

In the flexible portable terminal 10 according to the first exemplary embodiment, the single flexible battery 60 is disposed in a state of being positioned between the radio unit 40 and the board mounting unit 50 (the display control unit 52 and the processing unit 54) as illustrated in FIG. 2.

In contrast to this, in the flexible portable terminal 101 according to the third modified example, the first flexible battery 60-6 is disposed so as to overlap with an upper portion of a frame 32 of the casing 30, and the second flexible battery 60-7 is disposed so as to overlap with a lower portion of the frame 32 of the casing 30, as illustrated in FIG. 20. In other words, the first and second flexible batteries 60-6 and 60-7 are disposed so as to overlap with the two respective end portions of the frame 32, the end portions is orthogonal to the first and second end portions 11c and 11d (see FIG. 2).

Further, the height (thickness) T₄ of the flexible portable terminal 101 in the third modified example is thicker than the height (thickness) T₁ of the flexible portable terminal 10 according to the first exemplary embodiment.

Note that, although not illustrated in FIG. 20, the rigid constituent part is divided into the first rigid constituent part (40) including the radio unit 40 and the second rigid constituent part (50) including the board mounting unit 50 in the flexible portable terminal 101 according to the third modified example, as in the flexible portable terminal 10 according to the first exemplary embodiment. The first rigid constituent part (40) is disposed in the first end portion 11c, and the second rigid constituent part (50) is disposed in the second end portion 11d.

Hence, the flexible portable terminal 101 having the above-described structure is also bendable around the bend center BC (see FIG. 1), which is orthogonal to the center line CL (see FIG. 1), as the flexible portable terminal 10 according to the first exemplary embodiment.

The third modified example of the present invention described above provides the following fourth effect in addition to the first to third effects same as the first to third effects of the first exemplary embodiment described above.

The fourth effect is that, since the first and second flexible batteries 60-6 and 60-7 are disposed so as to overlap with the frame 32, the rigidity of the frame 32 disposed in the shorter-side direction of the terminal device (flexible portable terminal) 101 allows to improve.

The present invention has been described above with reference to the exemplary embodiments and modified examples. Now, the present invention is not limited to the above-described exemplary embodiments and modified examples. Various changes understood by those skilled in the art may be made to the configuration and details of the present invention within the scope of the present invention.

For example, in the above-described exemplary embodiments and modified examples, the first and second end portions correspond to the two respective longer-side-direction end portions of the terminal device (flexible portable terminal).

However, the first and second end portions may correspond to the two respective shorter-side-direction end portions of the terminal device (flexible portable terminal).

Moreover, in each of the above-described exemplary embodiments and modified examples, description is given by taking the example in which the terminal device (flexible portable device) is a tablet terminal (multifunctional portable terminal) with a display having a size of 10 inches. However, it is obvious that the display size is not limited to 10 inches. For example, the terminal device (flexible portable terminal) according to the present invention is applicable to any tablet terminal (multifunctional portable terminal) with a display having a size of 6 inches or larger.

### REFERENCE SIGNS LIST

10 to 10I Terminal device (flexible portable terminal)
11a First surface (main surface)
11b Second surface (back surface)
11c First end portion
11d Second end portion
20 Flexible display device
22 Screen (display surface)
24 Touch panel
25 Front panel
26 Display device
30, 30A Flexible casing
32, 32A Frame
34 Rear casing
40 Radio unit
41 Antenna
50 Board mounting unit
50a Edge
52 Display control unit
54 Processing unit
55 Small components
60 Flexible battery (organic radical battery)
60-1, 60-2 Flexible battery
60-6, 60-7 Flexible battery
60A Rigid battery
71 to 77 Operation key (hard key; operation button)
80 Component mounting unit
CL Center line
BC Bend center
W Lateral length (width)
W₁ Width of first end portion
W₂ Width of second end portion
L Longitudinal length (depth)
T₁ to T₄ Height (thickness)

This application is based upon and claims the benefit of priority from Japanese patent application No. 2014-055065, filed on Mar. 18, 2014, the disclosure of which is incorporated herein in its entirety by reference.

1. A terminal device provided with first and second end portions that are separate from each other, the terminal device comprising:
a flexible display device; and
a first constituent part and a second constituent part each including an electronic component,
wherein the first constituent part is disposed in the first end portion, and the second constituent part is disposed in the second end portion.

2. The terminal device according to claim 1, further comprising:
a first surface and a second surface facing each other; and
a flexible casing that surrounds the display device, the first constituent part, and the second constituent part,
wherein the flexible display device includes a display surface in the first surface, and
the terminal device is bendable around a bend center orthogonal to a center line passing through the first end portion and the second end portion.

3. The terminal device according to claim 2, wherein the first and second end portions correspond to two respective longer-side-direction end portions of the terminal device.

4. The terminal device according to claim 2,
wherein the first constituent part includes a radio unit including an antenna, and
the second constituent part includes a display control unit configured to control the flexible display device, and a processing unit configured to process data.

5. The terminal device according to claim 4, wherein the second constituent part includes a plurality of small components disposed on a side closer to the bend center.

6. The terminal device according to claim 4, further comprising a flexible battery,
wherein the flexible battery is disposed on the second surface in a state of being positioned between the first constituent part and the second constituent part.

7. The terminal device according to claim 4, further comprising:
a first flexible battery; and
a second flexible battery,
wherein the first flexible battery is disposed so as to overlap with the radio unit, and configures the first constituent part, and
the second flexible battery is disposed so as to overlap with the display control unit and the processing unit, and configures the second constituent part.

8. The terminal device according to claim 2,
wherein the first constituent part includes a constituent unit including an antenna, a display control unit configured to control the flexible display device, and a processing unit configured to processes data, and
the second constituent part includes a rigid battery.

9. The terminal device according to claim 4, further comprising:
a first flexible battery; and
a second flexible battery,
wherein the flexible casing includes a frame provided so as to surround a peripheral portion of the terminal device, and
the first and second flexible batteries are disposed so as to overlap with two respective end portions of the frame, the end portions being positioned on respective sides orthogonal to those of the first and second end portions.

10. The terminal device according to claim 2, further comprising at least one operation key provided in at least one of the first and second end portions.

11. The terminal device according to claim 2, wherein the flexible casing has a peripheral portion that is a curved surface in a convex shape curving outwards in a radius direction.

12. The terminal device according to claim 2, wherein four corners of the flexible casing are rounded.
